(19) United States
(12) Patent Application Publication
(10) Pub. No.: US 2006/0139401 A1
(43) Pub. Date: Jun. 29, 2006

(54) Ink jet printer

(76) Inventor: Yung-Chuan Wu, Pingjhen City (TW)

Correspondence Address: RABIN & Berdo, PC, 1101 14TH STREET, NW, SUITE 500, WASHINGTON, DC, 20005, US

(21) Appl. No.: 11/318,853

(22) Filed: Dec. 28, 2005

(30) Foreign Application Priority Data
Dec. 28, 2004 (TW) 93141032

(51) Int. Cl. B41J 23/00

(52) U.S. Cl. 347/37

(57) ABSTRACT

An ink jet printer includes a housing, a first guiding device and a second guiding device, a first chassis, and a second chassis. The first guiding device and the second guiding device are disposed in parallel in the housing. The first chassis and the second chassis are movably disposed on the first guiding device and the second guiding device respectively. The first chassis is for carrying a first print head assembly, and the second chassis is for carrying a second print head assembly. The first print head assembly and the second head assembly are moved simultaneously by the first guiding device and the second guiding device respectively to complete a print operation.

This application claims the benefit of Taiwan application Serial No. 93141032, filed Dec. 28, 2004, the subject matter of which is incorporated herein by reference.

### BACKGROUND OF THE INVENTION

1. Field of the Invention

The invention relates in general to a printer, and more particularly to an ink jet printer.

2. Description of the Related Art

Along with scientific developments, a printer becomes an essential image output device in people's daily lives. The common-used printer is divided into three types: a dot-matrix printer, a laser printer, and an ink jet printer.

The dot-matrix printer has a worse print quality and makes loud noise as printing and thus is used only in some special cases, such as when copy is required. The laser printer has a larger print speed and a better print quality, but a higher price. Therefore, it is too expensive to buy for some consumers, and thus not quite popular nowadays.

The ink jet printer spreads ink to papers vie small holes on the print head as performing a print operation. Therefore, the ink jet printer makes less noise as printing, and has a larger print speed and a better print quality than the dot-matrix printer. Moreover, along with development of the ink jet technology, the ink jet printer in present markets becomes very popular due to its fair price in addition to having a photograph-class print quality.

Although the ink jet printer has a larger print speed than the dot-matrix printer, in practical applications, the conventional ink jet printer still cannot meet the requirement of consumers on print speed. Therefore, a conventional ink jet printer is not applicable in the case when a large print amount is required, such as in offices of middle-scale and small-scale enterprises. Nowadays, a common solution is to widen the print head of the ink jet printer to increase its print speed. However, as the print head is made wider, the cost for manufacturing the print head becomes higher due to low throughout, and consequently, the ink jet printer having a wider print head becomes more expensive than a common ink jet printer. Therefore, how to improve print speed of the ink jet printer and provide consumers with a fair-priced ink jet printer is an essential subject for all the relevant industrials.

### SUMMARY OF THE INVENTION

It is therefore an object of the invention to provide an ink jet printer having the advantages of a high print speed, a high print quality, and a low manufacturing cost.

The invention achieves the above-identified object by providing an ink jet printer including a housing, a first guiding device and a second guiding device, and a first chassis and a second chassis. The first guiding device and the second guiding device are disposed in parallel in the housing. The first chassis and the second chassis are movably disposed on the first guiding device and the second guiding device respectively. The first chassis is for carrying a first print head assembly, and the second chassis is for carrying a second print head assembly. The first print head assembly and the second head assembly are moved simultaneously by the first guiding device and the second guiding device respectively to complete a print operation.

The invention achieves the above-identified object by providing an ink jet printer including a housing, a guiding device, and a first chassis and a second chassis. The guiding device is disposed in the housing. The first chassis and the second chassis are movably disposed on the guiding device. The first chassis is for carrying a first print head assembly and the second chassis is for carry a second print head assembly. The first print head assembly and the second head assembly are moved by the guiding device to complete a print operation.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of an ink jet printer according to the first embodiment of the invention.

FIG. 2A is a schematic diagram of one operation state of the guiding devices, chassis, print head assemblies and print media as the ink jet printer of FIG. 1 is printing.

FIG. 2B is a schematic diagram of another operation state of the guiding devices, chassis, print head assemblies and print media as the ink jet printer of FIG. 1 is printing.

FIG. 3 is a block diagram of an ink jet printer according to the second embodiment of the invention.

FIG. 4A is a schematic diagram of one operation state of the guiding device, chassis, print head assemblies and print media as the ink jet printer of FIG. 3 is printing.

FIG. 4B is a schematic diagram of another operation state of the guiding device, chassis, print head assemblies and print media as the ink jet printer of FIG. 3 is printing.

### DETAILED DESCRIPTION OF THE INVENTION

### EMBODIMENT ONE

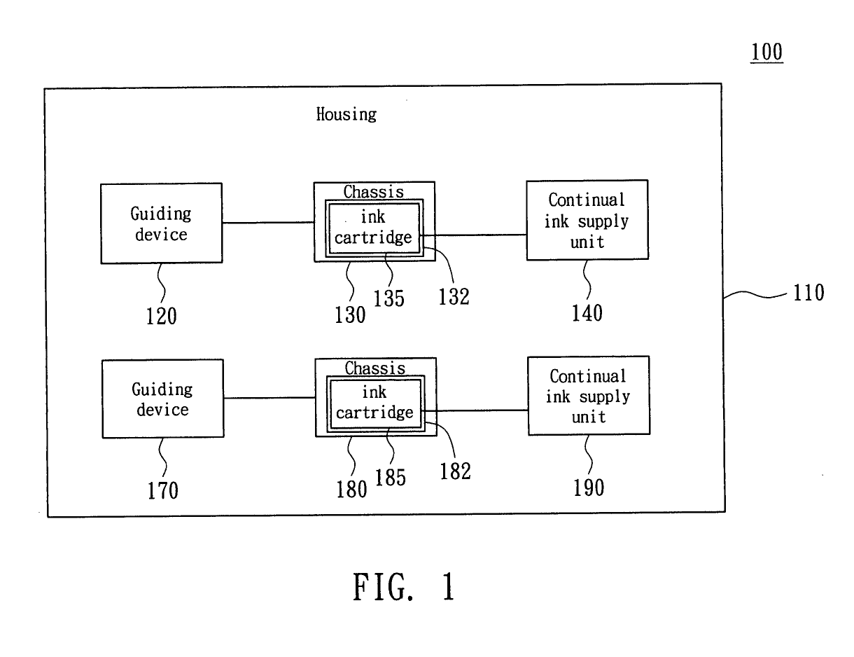

Referring to FIG. 1, a block diagram of an ink jet printer according to the first embodiment of the invention is shown. The ink jet printer 100 includes a housing 110, guiding devices 120 and 170, chassis 130 and 180, and continuously ink-supplying units 140 and 190. The guiding devices 120 and 170 are arranged in parallel in the housing 110, and each of them can include a motor, a guiding shaft, a gear wheel, and a belt etc. The chassis 130 and 180 are movably disposed on the guiding devices 120 and 170. The motor rotates the gear wheels and the belts connected to the chassis 130 and 180 to move the chassis 130 and 180 along the guiding shafts. The chassis 130 is for carrying a print head assembly 132 including at least an ink cartridge 135 while the chassis 180 is for carrying a print head assembly 182 including at least an ink cartridge 185. The ink cartridges 135 and 185 are for storing inks.

Continual ink supply units 140 and 190 are respectively coupled to the ink cartridges 135 and 185 for continuously supplying inks of the ink cartridges 135 and 185. The continual ink supply units 140 and 190 each has, for example, a number of ink bottles for containing inks of different colors. Each ink bottle preferably has a level detector for detecting the level of ink therein. When the ink in the ink bottle reaches a specific level, the level detector makes an alarm noise to inform the user to add ink.

It is noted that two continual ink supply units are taken as an example in the embodiment, however, the number of continual ink supply units are not limited thereto. For example, the ink jet printer 100 of the embodiment can also include only one continual ink supply unit coupled to the ink cartridges 135 and 185, for continuously supplying inks of the cartridges 135 and 185.

When the ink jet printer 100 is to perform a print operation, the chassis 130 and thus the print head assembly 132 are moved along the guiding device 120 while the chassis 180 and thus the print head assembly 182 are moved along the guiding device 170. That is, the print head assemblies 132 and 182 are respectively moved by the guiding devices 120 and 170 to perform a print operation in the first embodiment.

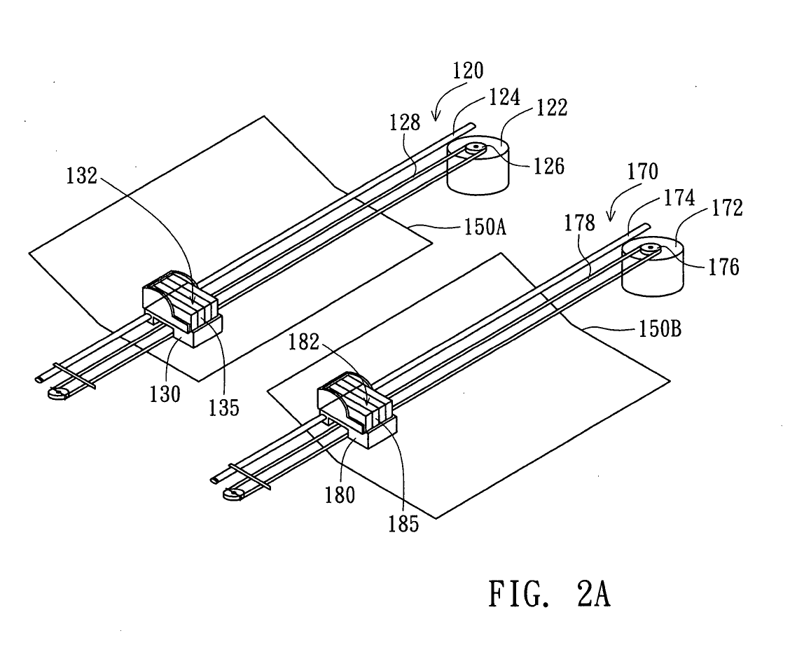

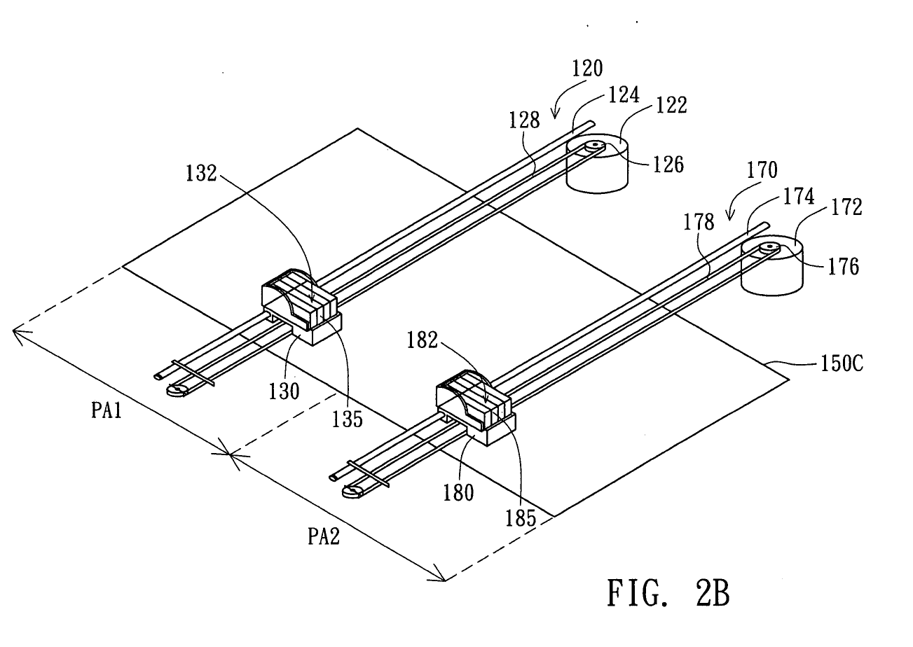

FIG. 2A is a schematic diagram of one operational state of the guiding devices, chassis, print head assemblies and print media as the ink jet printer of FIG. 1 is printing. Referring to FIG. 1 and FIG. 2A at the same time, the guiding devices 120 and 170 are disposed in parallel in the housing 110, while the chassis 130 for carrying the print head assembly 132 and the chassis 180 for carrying the print head assembly 182 are movably disposed on the guiding devices 120 and 170 respectively. The guiding device 120 includes, for example, a motor 122, a guiding shaft 124, a gear wheel 126, and a belt 128 while the guiding device 170 includes a motor 172, a guiding shaft 174, a gearwheel 176, and a belt 178, as shown in FIG. 2A.

In FIG. 2A, the print head assembly 132 is used to print a first image on a print medium 150A while the print head assembly 182 is used to print a second image on a print medium 150B, wherein the first image and the second image can be the same. Therefore, when the ink jet printer 100 performs a print operation, the guiding devices 120 and 170 respectively carry the print head assemblies 132 and 182 to move at the same time meanwhile the print head assemblies 132 and 182 can respectively print the first and the second images on the print media 150A and 150B, as shown in FIG. 2A. As a result, the ink jet printer 100 can simultaneously print two documents to increase its print speed.

The print head assemblies 132 and 182 in the ink jet printer 100 of the first embodiment can also commonly print an image on a print medium, as shown in FIG. 2B. Different from FIG. 2A, the print head assemblies 132 and 182 in FIG. 2B can commonly print an image on a print medium 150C.

For example, the print head assembly 132 is used for printing an area PA1 of the print medium 150C while the print head assembly 182 for printing an area PA2 of the print medium 150C. Therefore, when the ink jet printer 100 is to print an image on the print medium 150C, the guiding devices 120 and 170 respectively carry the print head assemblies 132 and 182 to move at the same time, meanwhile the print head assemblies 132 and 182 respectively print the areas PA1 and PA2 of the print medium 150C to complete a print operation. As a result, the ink jet printer 100 can spend only a half of the print time to complete printing the image.

Two pieces of chassis are taken as an example in the embodiment, however, the number of chassis in the ink jet printer can be altered according to practical requirement. For example, the ink jet printer can have five pieces of chassis, each chassis is moved by a respective guiding device, and the print head assembly carried by each chassis can be used to print a respective image on a print medium. As a result, the ink jet printer can simultaneously print five documents and be applicable in the case when a large print amount is required, such as in companies or offices of middle-scale and small-scale enterprises.

### EMBODIMENT TWO

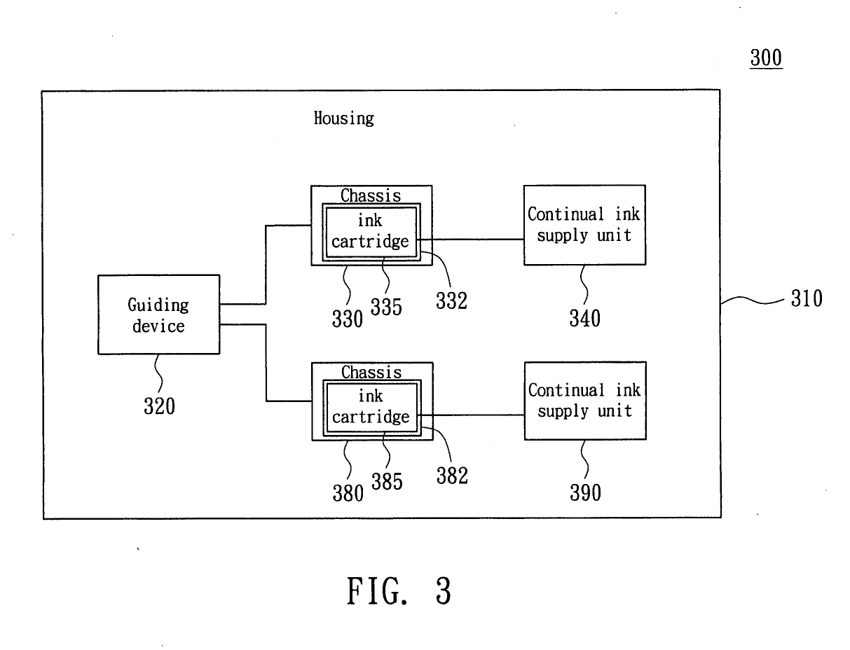

Referring to FIG. 3, a block diagram of an ink jet printer according to the second embodiment of the invention is shown. The ink jet printer 300 includes a housing 310, a guiding device 320, chassis 330 and 380, and continual ink supply units 340 and 390. The ink jet printer 300 of the second embodiment (in FIG. 3) has two pieces of chassis, the same with the ink jet printer 100 of the first embodiment. However, different from the first embodiment, the chassis 330 and 380 in the ink jet printer 300 of the second embodiment is movably disposed on a guiding device 320.

When the ink jet printer 300 is to perform a print operation, the guiding device 320 carry the chassis 330 and 380 simultaneously, meanwhile the print head assembly 332 carried by the chassis 330 and the print head assembly 382 carried by the chassis 380 can move along the guiding device 320 to perform the print operation. The print head assembly 332 includes at least an ink cartridge 335 while the print head assembly 382 includes at least an ink cartridge 385. The ink cartridges 335 and 385 are used for storing inks. The continual ink supply units 340 and 390 are respectively coupled to the ink cartridges 335 and 385 for supplying inks of the ink cartridges 335 and 385.

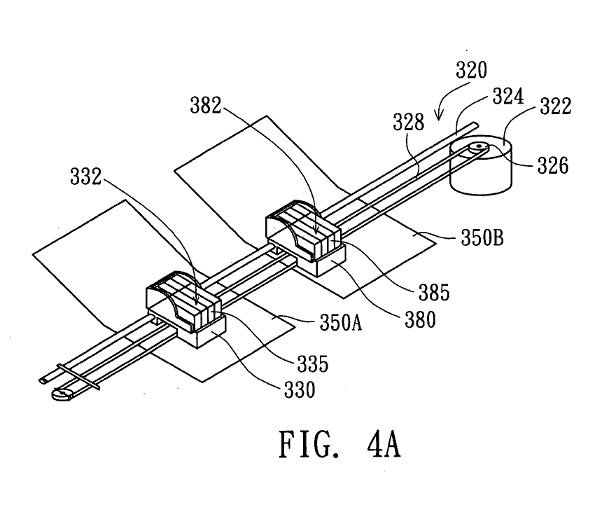

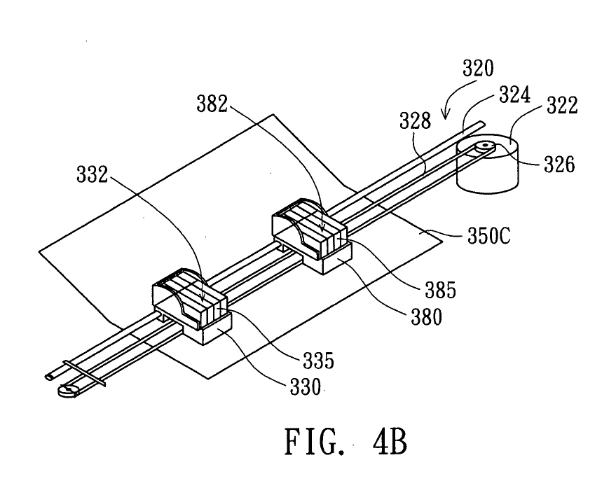

FIG. 4A is a schematic diagram of one operational state of the guiding device, chassis, print head assemblies and print media as the ink jet printer of FIG. 3 is printing. Referring to FIG. 3 and FIG. 4A at the same time, the chassis 330 for carrying the print head assembly 332 and the chassis 380 for carrying the print head assembly 382 are movably disposed on the guiding device 320. The guiding device 320 includes, for example, a motor 322, a guiding shaft 324, a gear wheel 326, and a belt 328, as shown in FIG. 4A.

In FIG. 4A, the print head assembly 332 is used to print a first image on a print medium 350A while the print head assembly 382 is used to print a second image on a print medium 350B, wherein the first image and the second image can be the same. Therefore, when the ink jet printer 300 performs a print operation, the guiding device 320 carries the print head assemblies 332 and 382 to move at the same time, meanwhile the print head assemblies 332 and 382 can respectively print the first and the second images on the print media 350A and 350B, as shown in FIG. 4A. As a result, the ink jet printer 300 can simultaneously print two documents and be applicable in the case when a large print amount is required.

The print head assemblies 332 and 382 in the ink jet printer 300 of the second embodiment can also commonly print an image on a print medium to shorten time of printing the image, as shown in FIG. 4B. Different from FIG. 4A, the print head assemblies 332 and 382 in FIG. 4B can commonly print an image on a print medium 350C.

It is noted that two pieces of chassis are taken as an example in the second embodiment, however, the number of chassis in the ink jet printer can be altered according to practical requirement. Moreover, the ink jet printer 300 of the second embodiment can also include one continuously ink-supplying unit coupled to the ink cartridges 335 and 385 for continuously supplying inks of the ink cartridges 335 and 385.

As mentioned above, by simultaneously using a number of print head assemblies to perform a print operation, the print speed of the ink jet printers can be increased. Therefore, as compared with the conventional ink jet printer using a wide print head to increase print speed, the ink jet printers as disclosed in the above-mentioned embodiments can not only increase print speed, shorten print time, but also reduce cost for manufacturing the ink jet printer and maintain a high print quality.

The ink jet printers disclosed in the above-mentioned embodiments have advantages of a high print speed, a high print quality and a low manufacturing cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An ink jet printer, comprising:
a housing;
a first guiding device and a second guiding device, disposed in parallel in the housing; and
a first chassis and a second chassis, movably disposed on the first guiding device and the second guiding device respectively, wherein the first chassis is for carrying a first print head assembly, and the second chassis is for carrying a second print head assembly;
wherein the first print head assembly and the second head assembly are moved simultaneously by the first guiding device and the second guiding device respectively to complete a print operation.

2. The ink jet printer according to claim 1, wherein the first print head assembly prints a first image on a first print medium and the second print head prints a second image on a second print medium.

3. The ink jet printer according to claim 2, wherein the first image and the second image are the same.

4. The ink jet printer according to claim 1, wherein the first print head assembly and the second print head assembly print commonly an image on a print medium.

5. The ink jet printer according to claim 1, wherein the first print head assembly comprises at least a first ink cartridge, the second print head assembly comprises at least a second ink cartridge, and the first cartridge and the second cartridge are for storing inks.

6. The ink jet printer according to claim 5, further comprising a continual ink supply unit for continuously supplying the inks of the first ink cartridge and the second cartridge.

7. The ink jet printer according to claim 5, further comprising a first continual ink supply unit and a second continual ink supply unit for continuously supplying the inks of the first cartridge and the second cartridge.

8. An ink jet printer, comprising:
a housing;
a guiding device, disposed in the housing; and
a first chassis and a second chassis, movably disposed on the guiding device, wherein the first chassis is for carrying a first print head assembly and the second chassis is for carry a second print head assembly;
wherein the first print head assembly and the second head assembly are moved by the guiding device to complete a print operation.

9. The ink jet printer according to claim 8, wherein the first print head assembly prints a first image on a first print medium and the second print head prints a second image on a second print medium.

10. The ink jet printer according to claim 9, wherein the first image and the second image are the same.

11. The ink jet printer according to claim 8, wherein the first print head assembly and the second print head assembly print commonly an image on a print medium.

12. The ink jet printer according to claim 8, wherein the first print head assembly comprises at least a first ink cartridge, the second print head assembly comprises at least a second ink cartridge, and the first cartridge and the second cartridge are for storing inks.

13. The ink jet printer according to claim 12, further comprising a continual ink supply unit for continuously supplying the inks of the first ink cartridge and the second cartridge.

14. The ink jet printer according to claim 12, further comprising a first continual ink supply unit and a second continual ink supply unit for continuously supplying the inks of the first cartridge and the second cartridge.
